(19) United States
(12) Patent Application Publication
(10) Pub. No.: US 2022/0077745 A1
(43) Pub. Date: Mar. 10, 2022

(54) Electric Motor

(71) Applicant: GKN Sinter Metals Engineering GmbH, Radevormwald (DE)

(72) Inventors: Hong Giang To, Düsseldorf (DE); Stefan Tiller, Sankt Augustin (DE); Maurice Andree, Neukirchen-Vluyn (DE)

(21) Appl. No.: 17/423,072

(22) PCT Filed: Dec. 17, 2019
(86) PCT No.: PCT/EP2019/085571

§ 371 Date: Jul. 14, 2021

(30) Foreign Application Priority Data
Jan. 15, 2019 (DE) 10 2019 100 907.3

(51) Int. Cl. H02K 5/20; H02K 21/24

(52) U.S. Cl. CPC H02K 5/207; H02K 21/24

(57) ABSTRACT

An electric motor (1), at least having: a housing (2) and a stator (3) situated therein with at least a plurality of coils (4); and a rotor (5) with at least one magnet (6), an axis of rotation (7) and an outer circumferential surface (8); wherein: the stator (3) and the rotor (5) are adjacent to one another along the axis of rotation (7); the rotor (5) has a fluid conduction structure (9) between the axis of rotation (7) and the outer circumferential surface (8); the fluid conduction structure (9) has at least one surface (13) extending at least radially (10) and being inclined relative to at least a circumferential direction (11), or to an axial direction (12) running parallel to the axis of rotation (7); and at least part of a fluid flow (14), transported through the fluid conduction structure (9) inside the housing (2) during the operation of the motor (1), can be conducted over the coils (4).

The present invention relates to an electric motor, wherein the electric motor comprises at least one stator and one rotor. In particular, the electric motor is an axial flux motor (AFM).

Electric motors generate heat during operation. If this heat is not dissipated to a sufficient extent, the electric motor heats up, as a result of which the efficiency can drop.

It is known to equip electric motors with cooling arrangements, wherein the heat is dissipated to a surrounding area or to a cooling fluid via a housing of the motor.

Proceeding from this, the object of the present invention is at least to mitigate or even to solve the problems outlined with respect to the prior art. In particular, the aim is to specify an electric motor which is of compact construction and has an efficient cooling device as well.

An electric motor according to the features of claim 1 is proposed for achieving these objects. The dependent claims relate to advantageous developments. The features listed individually in the claims can be combined with one another in any technologically feasible manner and can be supplemented by explanatory facts from the description and details from the figures, wherein further embodiment variants of the invention are indicated.

The invention proposes an electric motor, at least having
a housing and, arranged therein,
a stator with at least a plurality of coils and
a rotor with at least one magnet (preferably a plurality of magnets) and a rotation axis and an outer circumferential surface.

The stator and the rotor are arranged next to one another along the rotation axis. The rotor has a fluid-conducting structure between the rotation axis and the outer circumferential surface. The fluid-conducting structure has at least one surface extending at least in a radial direction and in so doing at least being designed inclined in relation to the circumferential direction or an axial direction parallel to the rotation axis (or to a plane arranged perpendicular to the rotation axis). A fluid flow, conveyed by the fluid-conducting structure during operation of the motor, can be conducted at least in part across the coils within the housing.

In particular, the invention proposes that the rotor of the motor drives a fluid circuit, that is to say generates a fluid flow within the housing, which fluid flow can be used to dissipate heat generated by the motor.

The coils are arranged next to one another in particular along a circumferential direction (on a common diameter). In particular, the magnet is arranged along the axial direction in alignment with the coils. In particular, the magnets of a plurality of magnets are arranged next to one another along a circumferential direction (on a common diameter, in particular along the axial direction in alignment with the coils). The number of magnets can differ from the number of coils or correspond to said number.

In particular, the electric motor is an axial flux motor which comprises at least one stator and one rotor which are arranged coaxially in relation to one another and next to one another along an axial direction.

The stator of the electric motor has, in particular, a soft-magnetic material, for example what is known as a “Soft-magnetic Composite” (SMC), or a combination of electrical sheets and SMC. The coils of the stator comprise cores which are preferably manufactured by pressing from a soft-magnetic material and baking. The SMC material is not sintered here. Instead, the temperature is controlled to below a melting point, but is sufficient for the cores to maintain their geometry permanently.

The rotor has, in particular, permanent magnets and/or soft-magnetic elements, for example in recesses. Permanent magnets can preferably be used to form a permanently excited synchronous or brushless DC motor, abbreviated to BDLC, while, for example, soft-magnetic elements can be used to produce a reluctance motor as the electric motor.

In particular, the rotor is produced at least partially by sintering. In particular, complex structures, for example fluid-conducting structures on the rotor, can be formed in a very simple manner by sintering.

The design of a stator, in particular using SMC, as well as further details, also relating to a rotor, can be found, for example, in WO 2016/066714 A1.

The electric motor has, in particular, an electrical power consumption (that is to say a maximum drive power) of less than 1000 watts (rated power), preferably of less than 500 watts, particularly preferably of less than 100 watts.

In particular, the motor can provide a rated power that is higher than that provided by known motors given a prespecified installation space.

In particular, the fluid-conducting structure is arranged solely between the rotation axis and the at least one magnet or magnets in the radial direction. As an alternative, the fluid-conducting structure extends in the radial direction solely over the extent of the magnet or magnets or as far as the outer circumferential surface of the rotor.

In particular, the rotor has an inner circumferential surface which is arranged at a distance from the rotation axis. In particular, the fluid-conducting structure extends between the inner circumferential surface and the outer circumferential surface over at least a portion of at least 20%, preferably at least 50%, particularly preferably of 100%, of the extent of the rotor along the radial direction between the inner circumferential surface and the outer circumferential surface.

In particular, the fluid-conducting structure and the at least one surface are formed (at least) by the one magnet or by at least one magnet (in particular by all of the magnets). That is to say, in particular, the at least one magnet or at least one of the magnets (in particular all of the magnets) has (have) a geometry by way of which the fluid-conducting structure is formed. That is to say, the geometry of the magnet has at least one surface extending at least in a radial direction and in so doing at least being designed inclined in relation to the circumferential direction or an axial direction parallel to the rotation axis.

The fluid-conducting structure can be arranged on a side of the rotor that faces the stator.

As an alternative or in addition, the fluid-conducting structure can be arranged on a side of the rotor that is averted from the stator.

In particular, the fluid flow flows across at least some (in particular all) of the coils along the axial direction.

In particular, the stator has, between at least two coils arranged adjacent to one another (preferably between all of the coils), a duct extending at least along the radial direction and via which the fluid flow can be conducted. In particular, the duct extends in the radial direction beyond the coils. In particular, the duct extends in the axial direction beyond the coils or at least over 80% of the extent of the coil along the axial direction.

In particular, the duct is designed to be permeable to the fluid flow along the axial direction toward the rotor. In particular, a fluid flow can be generated by way of rotation of the rotor and can be guided in the radial direction via the duct and along the coil surface.

In particular, the fluid flow can be conducted through the stator in the radial direction between the rotation axis and the plurality of coils along the axial direction. In particular, the fluid flow is conducted along the axial direction across the coils. In particular, the fluid flow is conducted across the coils downstream (with respect to the direction of flow of the fluid flow) of the rotor. As an alternative, the fluid flow is conducted across the coils upstream of the rotor.

In particular, the fluid-conducting structure or the rotor is designed at least partially in the manner of a fan impeller, so that a fluid flow is driven, in particular (at least substantially) in the radial direction, by way of the rotation of the rotor. In particular, a fluid flow can be drawn in by means of the rotor, in particular starting from the rotation axis, and conveyed to the outside in the radial direction by means of the rotor. As an alternative, a fluid flow can be drawn in starting from the outer circumferential surface and conveyed to the inside in the radial direction by means of the rotor.

In particular, the fluid-conducting structure is designed such that at least 1%, preferably at least 5%, particularly preferably at least 10% or at least 20%, of a current drive power of the motor is required for conveying the fluid flow. In particular, the fluid-conducting structure is designed such that at least 1%, preferably at least 5%, particularly preferably at least 10% or at least 20%, of a rated power of the motor is required for conveying the fluid flow.

The current drive power can be ascertained from the current operating parameters electric current and electrical voltage. The drive power, required for conveying the fluid flow, of the motor can be ascertained, in particular, in a test facility. The parameter “the drive power required for conveying the fluid flow” can be used, in particular, for describing the design of the fluid-conducting structure. In particular, a heat dissipation, effected by the fluid flow, out of the housing or away from the motor can be described by this parameter (that is to say a cooling power which is provided by the motor itself).

In particular, the fluid flow is used solely for cooling or controlling the temperature of the motor. In particular, the fluid of the fluid flow is not provided for any technical use other than cooling of the motor. The fluid is, in particular, air or a gas. However, the fluid can also be a liquid, in particular electrically non-conductive.

In particular, the motor can be sufficiently cooled at all (intended) operating points solely by the cooling power provided itself (as a result of the conveying of the fluid flow), and therefore overheating of the motor can be precluded.

As an alternative, additional cooling of the motor can be provided.

In particular, the motor is used for driving, for example, a pump. A medium other than the fluid of the fluid flow provided for cooling the motor is then conveyed by the pump.

In particular, the housing has an inlet and an outlet for exchanging the fluid flow. In particular, at least one of the inlet and outlet (preferably both) is (are) arranged at an end side of the housing (that is to say in particular along the axial direction in alignment with the stator and/or rotor). In particular, the inlet and the outlet are arranged on an identical end side of the housing.

In particular, the motor comprises a heat exchanger outside the housing, it being possible for a fluid volume, circulating in the motor, of the fluid flow to be cooled down by means of said heat exchanger. In particular, the fluid of the fluid flow is conveyed in a closed circuit.

In particular, the fluid flow is conducted within the housing such that the fluid flow flows across as large a portion of the coils or of the coil surface as possible. In particular, the largest portion of the thermal energy generated in the electric motor is generated in the coils. As a result of the fluid flow acting on the coils, heat can be dissipated as efficiently as possible.

By way of precaution, it is pointed out that the numerical words used here (“first”, “second”, “third”, . . . ) serve primarily (only) for distinction between several similar objects, dimensions or processes, that is to say in particular do not imperatively predefine a dependency and/or sequence of said objects, dimensions or processes with respect to one another. If a dependency and/or sequence is necessary, this will be explicitly stated here, or will emerge in an obvious manner to a person skilled in the art from a study of the embodiment being specifically described.

The invention and the technical field will be discussed in more detail below on the basis of the figures. It is pointed out that the invention is not intended to be restricted by the exemplary embodiments shown. In particular, unless explicitly presented otherwise, it is also possible for partial aspects of the substantive matter discussed in the figures to be extracted and combined with other constituent parts and knowledge from the present description and/or figures. The same reference signs are used to denote identical objects, such that, where appropriate, explanations from other figures can be taken into consideration in a supplementary manner. In the figures, in each case schematically:

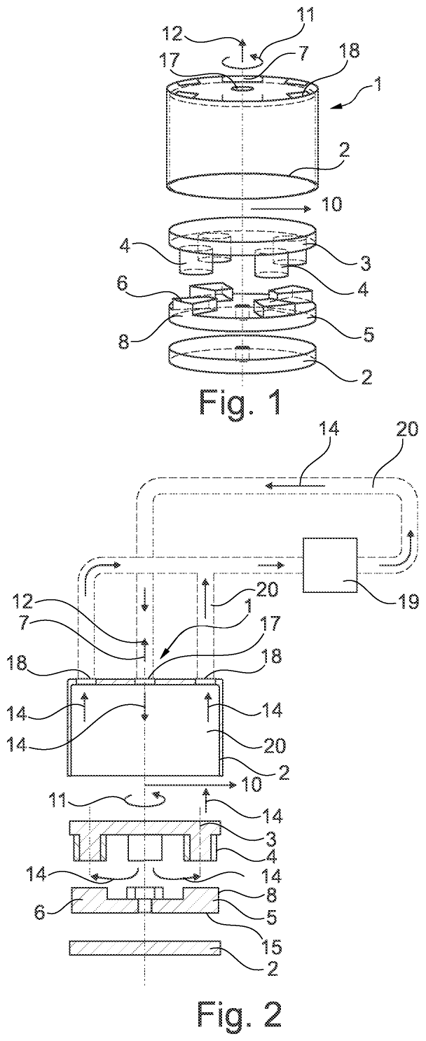

FIG. 1 shows a perspective view of an exploded illustration of an electric motor;

FIG. 2 shows a side view of an exploded illustration of the electric motor according to FIG. 1;

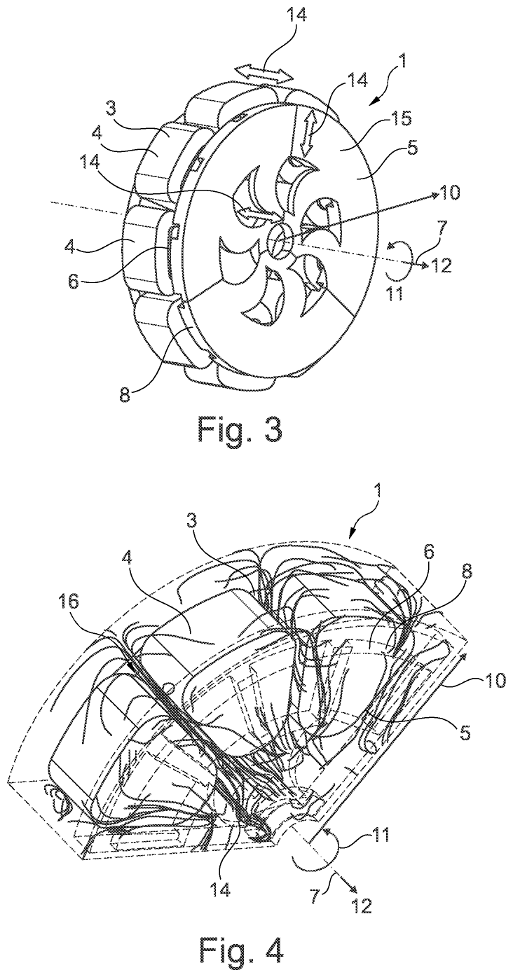

FIG. 3 shows a perspective view of a portion of a first embodiment variant of a motor;

FIG. 4 shows a perspective view of a portion of a stator and a rotor;

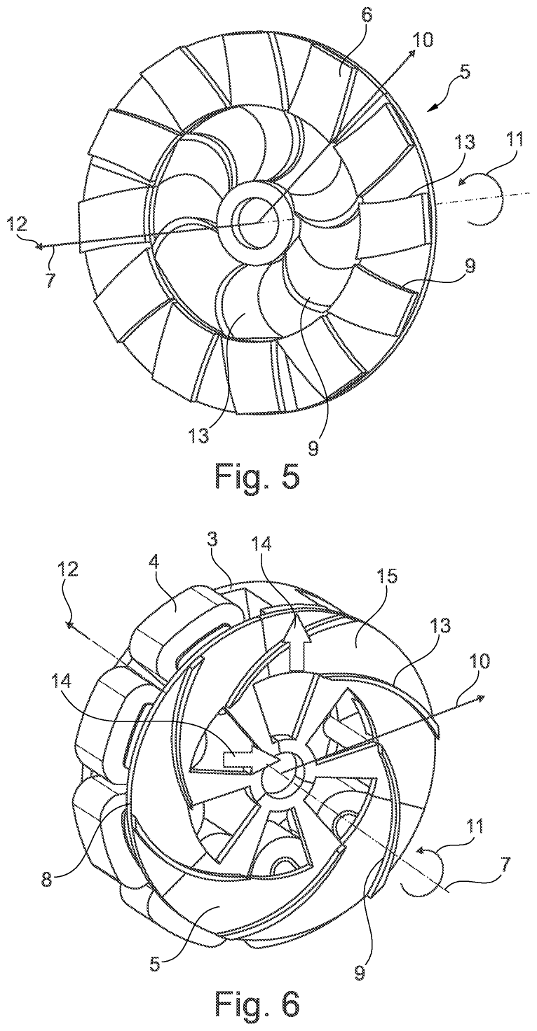

FIG. 5 shows a perspective view of a rotor; and

FIG. 6 shows a perspective view of a portion of a second embodiment variant of a motor.

FIG. 1 shows a perspective view of an exploded illustration of an electric motor 1. FIG. 2 shows a side view of an exploded illustration of the electric motor 1 according to FIG. 1. FIGS. 1 and 2 will be described together in the text which follows.

The motor 1, designed as an axial flux motor, comprises a housing 2 and, arranged herein, a stator 3 with four coils 4 and a rotor 5 with four magnets 6 and a rotation axis 7 and an outer circumferential surface 8. The stator 3 and the rotor 5 are arranged next to one another along the rotation axis 7.

The rotor 5 of the motor 1 drives a fluid circuit, that is to say generates a fluid flow 14 within the housing 2, which fluid flow can be used to dissipate heat generated by the motor 1.

The housing 2 has an inlet 17 (in alignment with the rotation axis 7) and a (multiple-part) outlet 18 for exchanging the fluid flow 14. The inlet 17 and the outlet 18 are arranged on an end side of the housing 2 (that is to say along the axial direction 12 in alignment with the stator 3 and the rotor 5).

The motor 1 comprises a heat exchanger 19 outside the housing 2, it being possible for a fluid volume 20, circulating in the motor 1, of the fluid flow 14 to be cooled down by means of said heat exchanger. The fluid of the fluid flow 14 is conveyed in a closed circuit.

The fluid flow 14 is conducted within the housing 2 such that the fluid flow 14 flows across as large a portion of the coils 4 or of the coil surface as possible.

The fluid flow 14 enters the housing 2 via the inlet 17, flows along the rotation axis 7, through the stator 3, as far as the rotor 5. Between the rotor 5 and the stator 3, the fluid flow 14 is deflected into the radial direction 10 and flows in the direction toward the outer circumferential surface 8 of the rotor 5. The fluid flow 14 is once again deflected by the housing 2 and flows along the axial direction 12 beyond the coils 4 and the stator 3 to the multiple-part outlet 18 in the housing 2.

FIG. 3 shows a perspective view of a portion of a first embodiment variant of a motor 1. Reference is made to the statements relating to FIGS. 1 and 2.

Said figure illustrates the stator 3 and the rotor 5 of the motor 1. The rotor 5 has a fluid-conducting structure 9 between the rotation axis 7 and the outer circumferential surface 8 (more precisely: and the magnets 6). The fluid-conducting structure 9 or the rotor 5 is designed at least partially in the manner of a fan impeller, so that a fluid flow 14 is driven by way of the rotation of the rotor 5. Therefore, a fluid flow 14 can be drawn in by means of the rotor 5, in particular starting from the rotation axis 7, and conveyed to the outside in the radial direction 10 by means of the rotor 5. As an alternative, a fluid flow 14 can be drawn in starting from the outer circumferential surface 8 and conveyed to the inside in the radial direction 10 by means of the rotor 5.

That is to say, here, the fluid flow 14 can be conveyed, depending on the direction of rotation of the rotor 5, along the radial direction 10 from the outer circumferential surface 8 toward the rotation axis 7 or from the rotation axis 7 toward the outer circumferential surface 8. The fluid flow 14 flows along the axial direction 12 in the region of the rotation axis 7 and in the region of the outer circumferential surface 8.

The fluid-conducting structure 9 is illustrated more clearly in FIG. 5.

FIG. 4 shows a perspective view of a portion of a stator 3 and of a rotor 5. Reference is made to the statements relating to FIGS. 1 to 3.

Here, the rotor 5 is illustrated in a transparent manner. The (partial) fluid flows 14 are illustrated as arrows here. The fluid flow 14 is conducted through the stator 3 in the radial direction 10 between the rotation axis 7 and the plurality of coils 4 along the radial direction 10.

For this purpose, the stator 5 has, between in each case two coils 4 arranged adjacent to one another, a duct 16 extending at least along the radial direction 10 and via which the fluid flow 14 can be conducted. The duct 16 extends beyond the coils 4 in the radial direction 10. The duct 16 extends across the coils 4 in the axial direction 12. The duct 16 is permeable or open to the fluid flow 14 along the axial direction 12 toward the rotor 5. A fluid flow 14 can be generated by way of rotation of the rotor 5 and guided in the radial direction 10 via the duct 16 and along the coil surface.

FIG. 5 shows a perspective view of a rotor 5. The rotor 5 has a fluid-conducting structure 9 between the rotation axis 7 and the outer circumferential surface 8. The fluid-conducting structure 9 has, between the rotation axis 7 and the magnets 6, a surface 13 extending at least in the radial direction 10 and in so doing at least being designed inclined in relation to the circumferential direction 11 and an axial direction 12 parallel to the rotation axis 7 (or to a plane arranged perpendicular to the rotation axis 7). The fluid-conducting structure 9 has, in the region of the magnets 6, a surface 13 extending in the radial direction 10 and in so doing being designed inclined in relation to the circumferential direction 11 (and parallel in relation to the axial direction 12).

Therefore, here, the magnets 6 are also configured in the form of a fan impeller. Therefore, the fluid-conducting structures 9 and the surfaces 13 are formed (at least) by the magnets 6. The magnets 6 have a geometry by way of which the fluid-conducting structure 9 is formed.

FIG. 6 shows a perspective view of a portion of a second embodiment variant of a motor 1. Said figure illustrates the stator 3 and the rotor 5 of the motor 1. Reference is made to the statements relating to FIGS. 1 to 5.

Here, a fluid-conducting structure 9 is arranged on a side 15 of the rotor 5 that is averted from the stator 3. The fluid-conducting structure 9 has, in the region of the magnets 6, a surface 13 extending in the radial direction 10 and in so doing being designed inclined in relation to the circumferential direction 11 (and parallel in relation to the axial direction 12). As a result of rotation of the rotor 5, a fluid flow 14 is conveyed, starting from the rotation axis 7, in the radial direction 10 outward to the outer circumferential surface 8.

### LIST OF REFERENCE SIGNS

1 Motor
2 Housing
3 Stator
4 Coil
5 Rotor
6 Magnet
7 Rotation axis
8 Outer circumferential surface
9 Fluid-conducting structure
10 Radial direction
11 Circumferential direction
12 Axial direction
13 Surface
14 Fluid flow
15 Side
16 Duct
17 Inlet
18 Outlet
19 Heat exchanger
20 Fluid volume

1. An electric motor, at least having a housing and, arranged therein, a stator with at least a plurality of coils and a rotor with at least one magnet and a rotation axis and an outer circumferential surface, wherein the stator and the rotor are arranged next to one another along the rotation axis, wherein the rotor has a fluid-conducting structure between the rotation axis and the outer circumferential surface, wherein the fluid-conducting structure has at least one surface extending at least in a radial direction and in so doing at least being designed inclined in relation to a circumferential direction or an axial direction parallel to the rotation axis, wherein a fluid flow conveyed by the fluid-conducting structure during operation of the motor, can be conducted at least in part across the coils within the housing.

2. The electric motor as claimed in claim 1, wherein the fluid-conducting structure is arranged between the rotation axis and the at least one magnet only in the radial direction.

3. The electric motor as claimed in claim 1, wherein the fluid-conducting structure and the at least one surface are formed by at least the one magnet.

4. The electric motor as claimed in claim 1, wherein the fluid-conducting structure is arranged on a side of the rotor that is averted from the stator.

5. The electric motor as claimed in claim 1, wherein the fluid flow flows across at least some of the coils along the axial direction.

6. The electric motor as claimed in claim 1, wherein the stator has, between at least two coils arranged adjacent to one another, a duct extending at least along the radial direction and via which the fluid flow can be conducted.

7. The electric motor as claimed in claim 6, wherein the duct is designed to be permeable to the fluid flow along the axial direction toward the rotor.

8. The electric motor as claimed in claim 1, wherein the fluid flow can be conducted through the stator in the radial direction between the rotation axis and the plurality of coils along the axial direction.

9. The electric motor as claimed in claim 1, wherein the fluid-conducting structure is designed such that at least 1% of a current drive power of the electric motor is required for conveying the fluid flow.

10. The electric motor as claimed in claim 1, wherein the housing has an inlet and an outlet for exchanging the fluid flow.

11. The electric motor as claimed in claim 1, wherein the electric motor comprises a heat exchanger outside the housing, it being possible for a fluid volume, circulating in the motor, of the fluid flow to be cooled down by said heat exchanger.
